(19) United States
(12) Patent Application Publication
(10) Pub. No.: US 2013/0003069 A1
(43) Pub. Date: Jan. 3, 2013

(54) OBJECT DETECTING DEVICE AND INFORMATION ACQUIRING DEVICE

(75) Inventors: Katsumi UMEDA, Niwa-gun (JP); Nobuo Iwatsuki, Anpachi-Gun (JP); Takaaki Morimoto, Kakogawa-shi (JP)

(73) Assignee: Sanyo Electric Co., Ltd., Moriguchi-shi (JP)

(21) Appl. No.: 13/616,691

(22) Filed: Sep. 14, 2012

Related U.S. Application Data
(63) Continuation of application No. PCT/JP2010/069458, filed on Nov. 2, 2010.

(30) Foreign Application Priority Data
Mar. 16, 2010 (JP) 2010-058625

(51) Int. Cl. G01N 21/55

(52) U.S. Cl. 356/445

(57) ABSTRACT

An information acquiring device has a laser light source which emits laser light of a predetermined wavelength band; a collimator lens which converts the laser light emitted from the laser light source into parallel light; an image sensor which receives reflected light reflected on a target area for outputting a signal; and a CPU which acquires three-dimensional information of an object in the target area based on the signal to be outputted from the image sensor. A light diffractive portion for converting the laser light into laser light having a dot pattern by diffraction is integrally formed on a light exit surface of the collimator lens.

This application claims priority under 35 U.S.C. Section 119 of Japanese Patent Application No. 2010-58625 filed Mar. 16, 2010, entitled “OBJECT DETECTING DEVICE AND INFORMATION ACQUIRING DEVICE”. The disclosure of the above application is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A certain type of a distance image sensor is configured to irradiate a target area with laser light having a predetermined dot pattern. In the distance image sensor, reflected light of laser light from the target area at each dot position on the dot pattern is received by a light receiving element. The distance image sensor is operable to detect a distance to each portion (each dot position on the dot pattern) of an object to be detected, based on the light receiving position of laser light on the light receiving element corresponding to each dot position, using a triangulation method (see e.g. pp. 1279-1280, the 19th Annual Conference Proceedings (Sep. 18-20, 2001) by the Robotics Society of Japan).

In the object detecting device thus constructed, after laser light is collimated into parallel light by e.g. a collimator lens, the laser light is entered to a DOE (Diffractive Optical Element) and is converted into laser light having a dot pattern. Thus, in the above arrangement, a space for disposing the collimator lens and the DOE is necessary at a position posterior to a laser light source. Accordingly, the above arrangement involves a drawback that the size of a projection optical system may be increased in the optical axis direction of laser light.

### SUMMARY OF THE INVENTION

A first aspect of the invention is directed to an information acquiring device for acquiring information on a target area using light. The information acquiring device according to the first aspect includes a light source which emits light of a predetermined wavelength band; a collimator lens which converts the laser light emitted from the light source into parallel light; a light diffractive portion which is formed on a light incident surface or a light exit surface of the collimator lens, and converts the laser light into laser light having a dot pattern by diffraction of the light diffractive portion; a light receiving element which receives reflected light reflected on the target area for outputting a signal; and an information acquiring section which acquires three-dimensional information of an object in the target area based on the signal to be outputted from the light receiving element.

A second aspect of the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIGS. 4A and 4B are diagrams respectively showing arrangements of projection optical systems in the embodiment and in a comparative example.

FIGS. 5A through 5C are diagrams showing a process of forming a light diffractive portion in the embodiment, and FIG. 5D is a diagram showing a setting example of the light diffractive portion.

FIGS. 6A through 6F are diagrams showing simulations regarding aberrations of collimator lenses in the embodiment and in the comparative example.

FIGS. 7A through 7C are diagrams showing an arrangement of a tilt correction mechanism in the embodiment.

FIG. 8 is a timing chart showing a light emission timing of laser light, an exposure timing for an image sensor and an image data storing timing in the embodiment.

FIG. 9 is a flowchart showing an image data storing processing in the embodiment.

FIGS. 10A and 10B are flowcharts showing an image data subtraction processing in the embodiment.

FIGS. 11A through 11D are diagrams schematically showing an image data processing process in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, a laser light source 111 corresponds to a “light source” in the claims. A CMOS image sensor 125 corresponds to a “light receiving element” in the claims. A data subtractor 21b and a three-dimensional distance calculator 21c correspond to an “information acquiring section” in the claims. A laser controller 21a corresponds to a “light source controller” in the claims. A memory 25 corresponds to a “storage” in the claims. The description regarding the correspondence between the claims and the embodiment is merely an example, and the claims are not limited by the description of the embodiment.

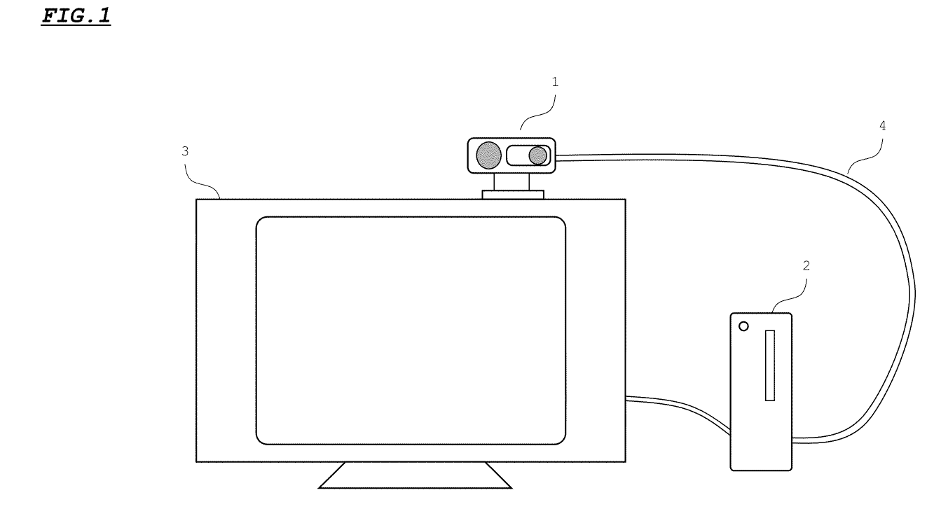

A schematic arrangement of an object detecting device according to the first embodiment is shown in FIG. 1. As shown in FIG. 1, the object detecting device is provided with an information acquiring device 1, and an information processing device 2. ATV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

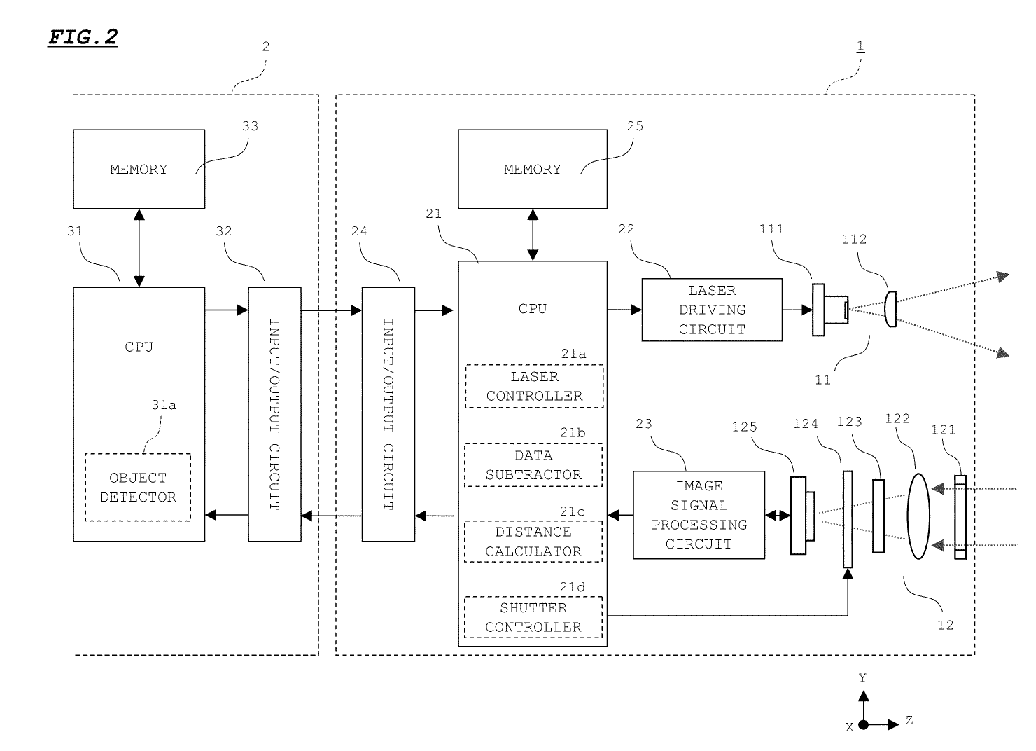

FIG. 2 is a diagram showing an arrangement of the information acquiring device 1 and the information processing device 2.

The information acquiring device 1 is provided with a projection optical system 11 and a light receiving optical system 12, which constitute an optical section. The projection optical system 11 is provided with a laser light source 111, and a collimator lens 112. The light receiving optical system 12 is provided with an aperture 121, an imaging lens 122, a filter 123, a shutter 124, and a CMOS image sensor 125. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

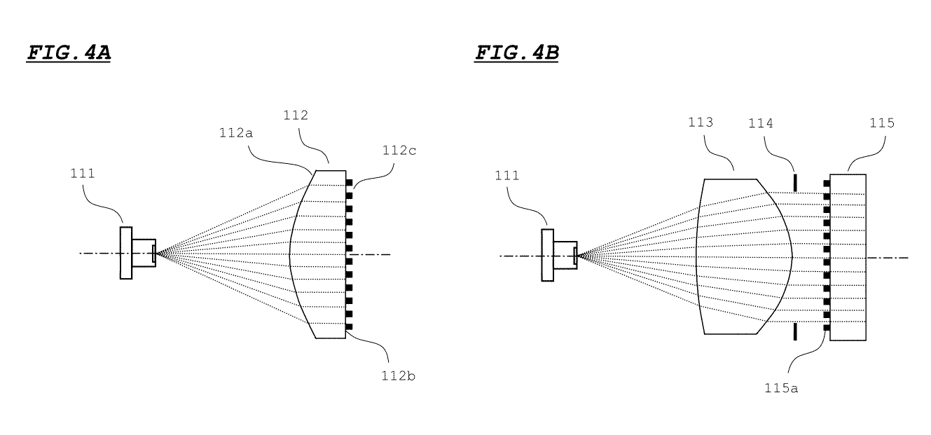

The laser light source 111 outputs laser light in a narrow wavelength band of or about 830 nm. The collimator lens 112 converts the laser light emitted from the laser light source 111 into parallel light. A light diffractive portion 112c (see FIG. 4A) having a function of a DOE (Diffractive Optical Element) is formed on a light exit surface of the collimator lens 112. With use of the light diffractive portion 112c, the laser light is converted into laser light having a dot matrix pattern, and is irradiated onto a target area.

Laser light reflected on the target area is entered to the imaging lens 122 through the aperture 121. The aperture 121 limits external light in accordance with the F-number of the imaging lens 122. The imaging lens 122 condenses the light entered through the aperture 121 on the CMOS image sensor 125.

The filter 123 is a band-pass filter which transmits light in a wavelength band including the emission wavelength band (in the range of about 830 nm) of the laser light source 111, and blocks light in a visible light wavelength band. The filter 123 is not a narrow band-pass filter which transmits only light in a wavelength band of or about 830 nm, but is constituted of an inexpensive filter which transmits light in a relatively wide wavelength band including a wavelength of 830 nm.

The shutter 124 blocks or transmits light from the filter 123 in accordance with a control signal from the CPU 21. The shutter 124 is e.g. a mechanical shutter or an electronic shutter. The CMOS image sensor 125 receives light condensed on the imaging lens 122, and outputs a signal (electric charge) in accordance with a received light amount to the image signal processing circuit 23 pixel by pixel. In this example, the CMOS image sensor 125 is configured in such a manner that the output speed of signals to be outputted from the CMOS image sensor 125 is set high so that a signal (electric charge) at each pixel can be outputted to the image signal processing circuit 23 with high response from a light receiving timing at each pixel.

The CPU 21 controls the parts of the information acquiring device 1 in accordance with a control program stored in the memory 25. By the control program, the CPU 21 has functions of a laser controller 21a for controlling the laser light source 111, a data subtractor 21b to be described later, a three-dimensional distance calculator 21c for generating three-dimensional distance information, and a shutter controller 21d for controlling the shutter 124.

The laser driving circuit 22 drives the laser light source 111 in accordance with a control signal from the CPU 21. The image signal processing circuit 23 controls the CMOS image sensor 125 to successively read signals (electric charges) from the pixels, which have been generated in the CMOS image sensor 125, line by line. Then, the image signal processing circuit 23 outputs the read signals successively to the CPU 21. The CPU 21 calculates a distance from the information acquiring device 1 to each portion of an object to be detected, by a processing to be implemented by the three-dimensional distance calculator 21c, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

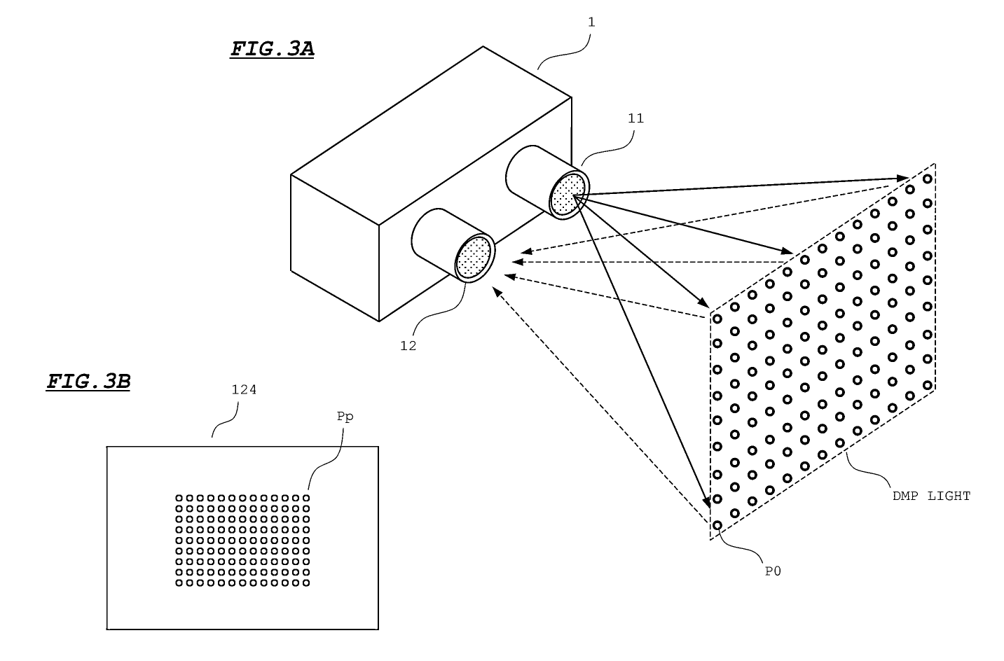

The input/output circuit 32 controls data communication with the information acquiring device 1. FIG. 3A is a diagram schematically showing an irradiation state of laser light onto a target area. FIG. 3B is a diagram schematically showing a light receiving state of laser light on the CMOS image sensor 125. To simplify the description, FIG. 3B shows a light receiving state in the case where a flat plane (screen) is disposed on a target area.

As shown in FIG. 3A, laser light (hereinafter, the entirety of laser light having a dot matrix pattern is called as “DMP light”) having a dot matrix pattern is irradiated from the projection optical system 11 onto a target area. FIG. 3A shows a light flux cross section of DMP light by a broken-line frame. Each dot in DMP light schematically shows a region where the intensity of laser light is locally enhanced by a light diffractive portion 112c on the light exit surface of the collimator lens 112. The regions where the intensity of laser light is locally enhanced appear in the light flux of DMP light in accordance with a predetermined dot matrix pattern.

In the case where a flat plane (screen) is disposed in a target area, light of DMP light reflected on the flat plane at each dot position is distributed on the CMOS image sensor 125, as shown in FIG. 3B. For instance, light at a dot position PO on a target area corresponds to light at a dot position Pp on the CMOS image sensor 125.

The three-dimensional distance calculator 21c is operable to detect to which position on the CMOS image sensor 125, the light corresponding to each dot is entered, for detecting a distance to each portion (each dot position on a dot matrix pattern) of an object to be detected, based on the light receiving position, by a triangulation method. The details of the above detection technique is disclosed in e.g. pp. 1279-1280, the 19th Annual Conference Proceedings (Sep. 18-20, 2001) by the Robotics Society of Japan.

According to the distance detection as described above, it is necessary to accurately detect a distribution state of DMP light (light at each dot position) on the CMOS image sensor 125. However, since the inexpensive filter 123 having a relatively wide transmittance wavelength band is used in this embodiment, light other than DMP light may be entered to the CMOS image sensor 125, as ambient light. For instance, if an illuminator such as a fluorescent lamp is disposed in a target area, an image of the illuminator may be included in an image captured by the CMOS image sensor 125, which results in inaccurate detection of a distribution state of DMP light.

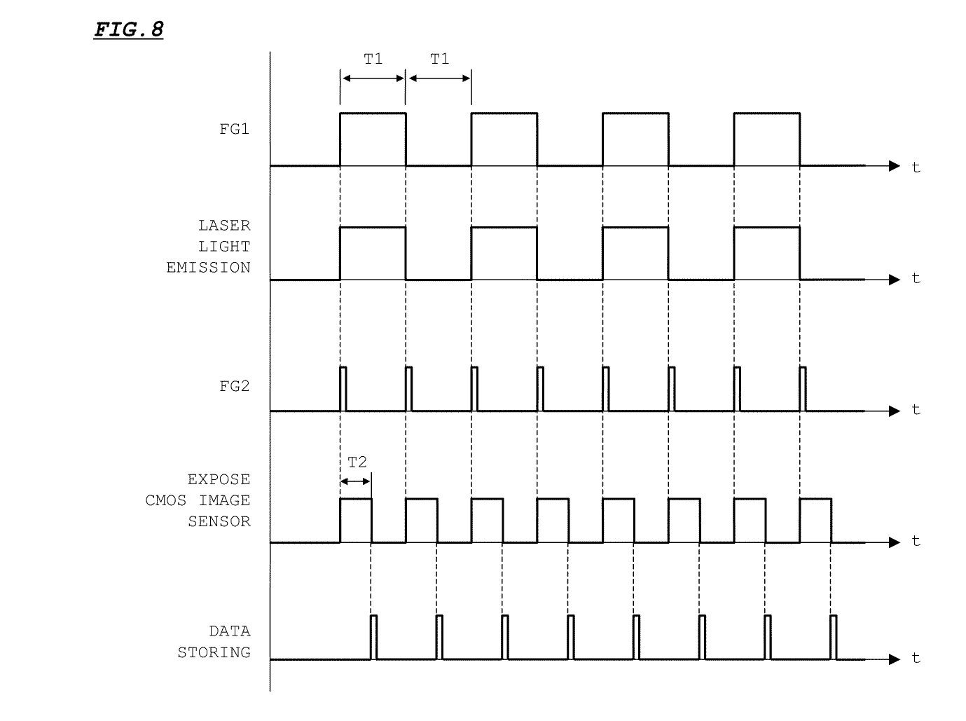

In view of the above, in this embodiment, detection of a distribution state of DMP light is optimized by a processing to be described later. The processing is described referring to FIGS. 8 through 11D.

FIG. 4A is a diagram showing details of an arrangement of a projection optical system in the embodiment, and FIG. 4B is a diagram showing an arrangement of a projection optical system in a comparative example.

As shown in FIG. 4B, in the comparative example, after laser light emitted from a laser light source 111 is converted into parallel light by a collimator lens 113, the laser light is converged by an aperture 114 and entered to a DOE 115. A light diffractive portion 115a for converting the laser light entered as parallel light into laser light having a dot matrix pattern is formed on a light incident surface of the DOE 115. Thus, laser light is irradiated onto a target area as laser light having a dot matrix pattern.

As described above, in the comparative example, the collimator lens 113, the aperture 114, and the DOE 115 are disposed at a position posterior to the laser light source 111 for generating laser light having a dot matrix pattern. As a result, the size of the projection optical system in the optical axis direction of laser light is increased.

On the other hand, in the embodiment, as shown in FIG. 4A, the light diffractive portion 112c is formed on a light exit surface of the collimator lens 112. The collimator lens 112 has a light incident surface 112a which is formed into a curved surface, and a light exit surface 112b which is formed into a flat surface. The surface configuration of the light incident surface 112a is so designed as to convert laser light to be entered from the laser light source 111 into parallel light by refraction. The light exit surface 112b as a flat surface is formed with the light diffractive portion 112c for converting laser light entered as parallel light into laser light having a dot matrix pattern. In this way, laser light is irradiated onto a target area as laser light having a dot matrix pattern.

As described above, in the embodiment, since the light diffractive portion 112c is integrally formed on the light exit surface of the collimator lens 112, there is no need of additionally providing a space for disposing a DOE. Thus, the size of the projection optical system in the optical axis direction of laser light can be reduced, as compared with the arrangement shown in FIG. 4B.

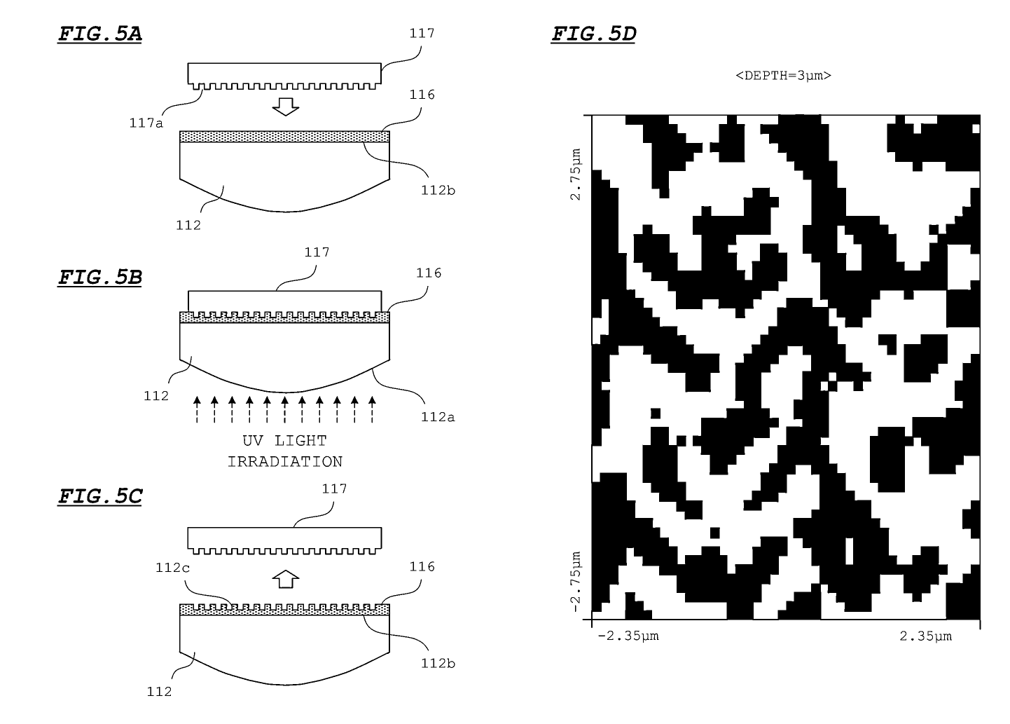

FIGS. 5A through 5C are diagrams showing an example of a process of forming the light diffractive portion 112c.

In the forming process, firstly, as shown in FIG. 5A, a UV curable resin is coated on the light exit surface 112b of the collimator lens 112, and a UV curable resin layer 116 is formed. Then, as shown in FIG. 5B, a stumper 117 having a concave-convex configuration 117a for generating laser light having a dot matrix pattern is pressed against an upper surface of the UV curable resin layer 116. In this state, UV light is irradiated from the light incident surface 112a side of the collimator lens 112 to cure the UV curable resin layer 116. Thereafter, as shown in FIG. 5C, the UV cured resin layer 116 is peeled off from the stamper 117. By performing the above operation, the concave-convex configuration 117a of the stamper 117 is transferred onto the upper surface of the UV cured resin layer 116. In this way, the light diffractive portion 112c for generating laser light having a dot matrix pattern is formed on the light exit surface 112b of the collimator lens 112.

FIG. 5D is a diagram showing a setting example of a diffraction pattern of the light diffractive portion 112c. In FIG. 5D, black portions are stepped grooves of 3 μm depth with respect to white portions. The light diffractive portion 112c has a periodic structure corresponding to a diffraction pattern.

Alternatively, the light diffractive portion 112c may be formed by a process other than the forming process shown in FIGS. 5A through 5C. Further alternatively, the light exit surface 112b itself of the collimator lens 112 may have a concave-convex configuration (a configuration for diffraction) for generating laser light having a dot matrix pattern. For instance, in the case where the collimator lens 112 is formed by injection molding using a resin material, a configuration for transferring a diffraction pattern may be formed in an inner surface of a die for injection molding. This is advantageous in forming the collimator lens 112 in a simplified manner, because there is no need of performing a step of forming the light diffractive portion 112c on the light exit surface of the collimator lens 112.

In the embodiment, since the light exit surface 112b of the collimator lens 112 is formed into a flat surface, and the light diffractive portion 112c is formed on the flat surface, it is relatively easy to form the light diffractive portion 112c. On the other hand, however, since the light exit surface 112b is a flat surface, an aberration of laser light generated on the collimator lens 112 may be increased, as compared with an arrangement that both of a light incident surface and a light exit surface of a collimator lens are formed into a curved surface. Normally, both of the shapes of the light incident surface and the light exit surface of the collimator lens 112 are adjusted to suppress an aberration. In this case, both of the light incident surface and the light exit surface are formed into an aspherical shape. By adjusting the shapes of the light incident surface and the light exit surface as described above, it is possible to realize conversion into parallel light and suppression of an aberration concurrently. In the embodiment, however, since only the light incident surface is formed into a curved surface, there is a limit in suppressing an aberration. Thus, in the embodiment, an aberration of laser light may be increased, as compared with an arrangement that both of a light incident surface and a light exit surface of a collimator lens are formed into a curved surface.

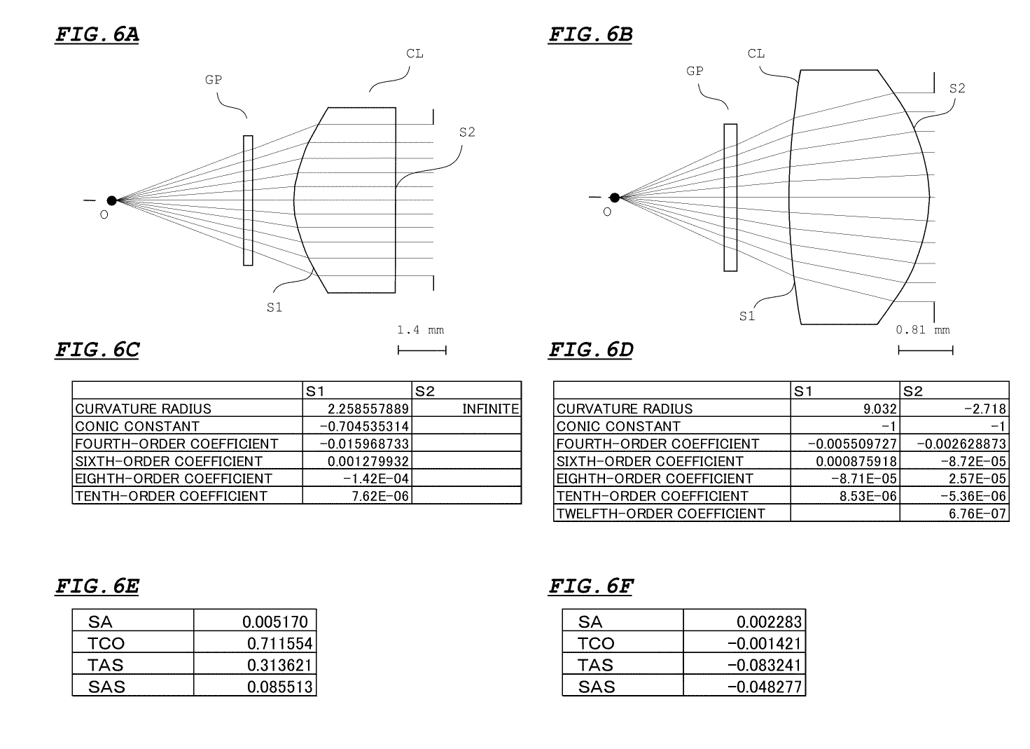

FIGS. 6A through 6F respectively show simulation results which verify aberration generation conditions of a collimator lens (comparative example) in which both of a light incident surface and a light exit surface are formed into a curved surface, and a collimator lens (present example) in which a light exit surface is formed into a flat surface. FIGS. 6A and 6B are diagrams respectively showing arrangements of optical systems proposed in the simulations on the present example and the comparative example. FIGS. 6C and 6D are diagrams respectively showing parameter values which define the shapes of a light incident surface S1 and a light exit surface S2 of a collimator lens in each of the present example and the comparative example. FIGS. 6E and 6F are diagrams respectively showing simulation results on the present example and the comparative example. In FIGS. 6A and 6B, CL denotes a collimator lens, O denotes a light emission point of a laser light source, and GP denotes a glass plate mounted on a light emission opening of a CAN of the laser light source. The other parameter values in the simulation condition are as shown in the following table.

| Laser wavelength | 830 | nm |
|---|---|---|
| Effective diameter of collimator lens | 3.7 | mm |
| Distance between collimator lens and image plane | 1000 | mm |
| Refractive index of collimator lens | 1.492 | |
| Abbe number of collimator lens | 55.33 | |
| Thickness of collimator lens | 2.71 | mm |
| Refractive index of glass plate | 1.517 | |
| Abbe number of glass plate | 64.2 | |
| Thickness of glass plate | 0.25 | mm |

In the simulation results shown in FIGS. 6E and 6F, SA denotes a spherical aberration, TCO denotes a coma aberration, TAS denotes an astigmatism (in a tangential direction) and SAS denotes an astigmatism (in a sagittal direction).

Comparing between the simulation results shown in FIGS. 6E and 6F, there is no significant difference in spherical aberration (SA) between the present example and the comparative example. On the other hand, there is a relatively large difference in coma aberration (TCO) and astigmatisms (TAS, SAS) between the present example and the comparative example. The spherical aberration is an on-axis aberration, and the coma aberration and the astigmatisms are off-axis aberrations. An off-axis aberration significantly increases, as a tilt of the optical axis of the collimator lens with respect to the optical axis of laser light increases. In view of the above, in the case where the light exit surface is formed into a flat surface as in the embodiment, it is desirable to provide a tilt correction mechanism for aligning the optical axis of the collimator lens 112 with the optical axis of laser light.

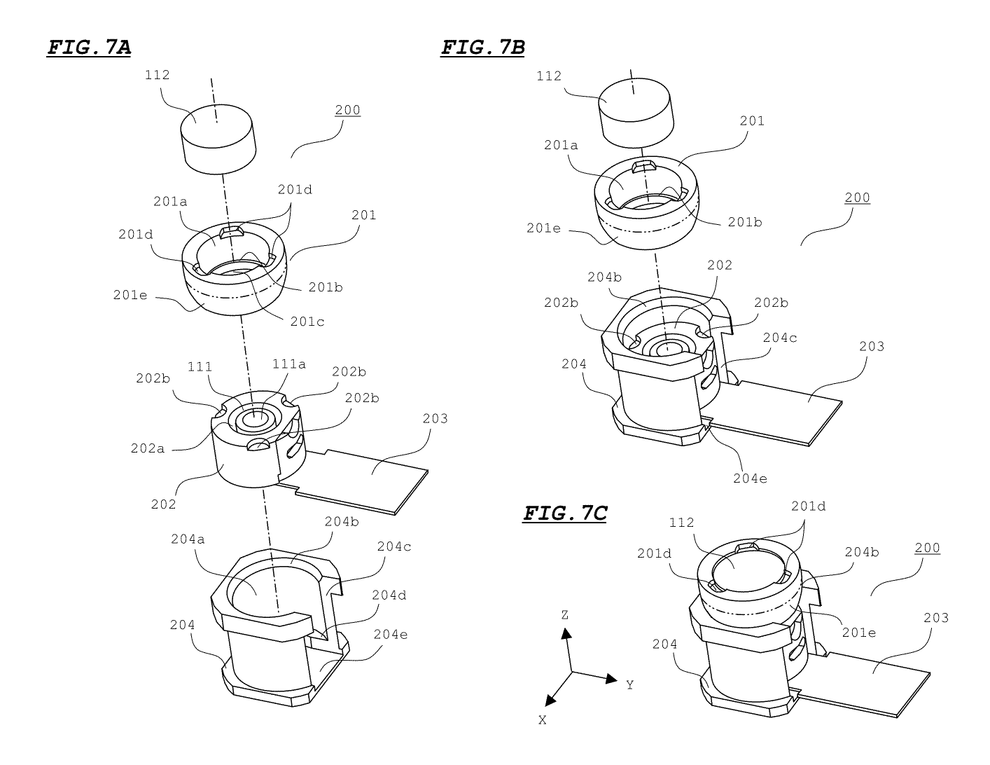

FIGS. 7A through 7C are diagrams showing an arrangement example of a tilt correction mechanism 200. FIG. 7A is an exploded perspective view of the tilt correction mechanism 200, and FIGS. 7B and 7C are diagrams showing a process of assembling the tilt correction mechanism 200.

Referring to FIG. 7A, the tilt correction mechanism 200 is provided with a lens holder 201, a laser holder 202, and a base member 204.

The lens holder 201 has a top-like shape and is symmetrical with respect to an axis. The lens holder 201 is formed with a lens accommodation portion 201a capable of receiving the collimator lens 112 from above. The lens accommodation portion 201a has a cylindrical inner surface, and the diameter thereof is set slightly larger than the diameter of the collimator lens 112.

An annular step portion 201b is formed on a lower portion of the lens accommodation portion 201a. A circular opening 201c continues from the step portion 201b in such a manner that the opening 201c opens to the outside from a bottom surface of the lens holder 201. The inner diameter of the step portion 201b is set smaller than the diameter of the collimator lens 112. The dimension from the top surface of the lens holder 201 to the step portion 201b is set slightly larger than the thickness of the collimator lens 112 in the optical axis direction.

The top surface of the lens holder 201 is formed with three cut grooves 201d. Further, a bottom portion (a portion beneath the two-dotted chain-line in FIG. 7A) of the lens holder 201 is formed into a spherical surface 201e. The spherical surface 201e is surface-contacted with a receiving portion 204b on the top surface of the base member 204, as described later.

The laser light source 111 is accommodated in the laser holder 202. The laser holder 202 has a cylindrical shape, and an opening 202a is formed in the top surface of the laser holder 202. A glass plate 111a (light emission window) of the laser light source 111 faces the outside through the opening 202a. The top surface of the laser holder 202 is formed with three cut grooves 202b. A flexible printed circuit board (FPC) 203 for supplying electric power to the laser light source 111 is mounted on the lower surface of the laser holder 202.

A laser accommodation portion 204a having a cylindrical inner surface is formed in the base member 204. The diameter of the inner surface of the laser accommodation portion 204a is set slightly larger than the diameter of an outer periphery of the laser holder 202. A spherical receiving portion 204b to be surface-contacted with the spherical surface 201e of the lens holder 201 is formed on the top surface of the base member 204. Further, a cutaway 204c for passing through the FPC 203 is formed in a side surface of the base member 204. A step portion 204e is formed to continue from a lower end 204d of the laser accommodation portion 204a. When the laser holder 202 is accommodated in the laser accommodation portion 204a, a gap is formed between the FPC 203 and the bottom surface of the base member 204 by the step portion 204e. The gap avoids contact of the back surface of the FPC 203 with the bottom surface of the base member 204.

As shown in FIG. 7B, the laser holder 202 is received in the laser accommodation portion 204a of the base member 204 from above. After the laser holder 202 is received in the laser accommodation portion 204a to such an extent that the lower end of the laser holder 202 is abutted against the lower end 204d of the laser accommodation portion 204a, an adhesive is applied in the cut grooves 202b formed in the top surface of the laser holder 202. By the application, the laser holder 202 is fixedly mounted on the base member 204.

Then, the collimator lens 112 is received in the lens accommodation portion 201a of the lens holder 201. After the collimator lens 112 is received in the lens accommodation portion 201a to such an extent that the lower end of the collimator lens 112 is abutted against the step portion 201b of the lens accommodation portion 201a, an adhesive is applied in the cut grooves 201d formed in the top surface of the lens holder 201. By the application, the collimator lens 112 is mounted on the lens holder 201.

Thereafter, as shown in FIG. 7C, the spherical surface 201e of the lens holder 201 is placed on the receiving portion 204b of the base member 204. In this arrangement, the lens holder 201 is swingable in a state that the spherical surface 201e is in sliding contact with the receiving portion 204b.

Thereafter, the laser light source 111 is caused to emit light, and the beam diameter of laser light transmitted through the collimator lens 112 is measured by a beam analyzer. At the measurement, the lens holder 201 is caused to swing using a jig. As described above, the beam diameter is measured while swinging the lens holder 201 to position the lens holder 201 at such a position that the beam diameter becomes smallest. Then, a circumferential surface of the lens holder 201 and the top surface of the base member 204 are fixed to each other at the above position by an adhesive. Thus, tilt correction of the collimator lens 112 with respect to the optical axis of laser light is performed, and the collimator lens 112 is fixed at such a position that an off-axis aberration becomes smallest.

In the arrangement shown in FIGS. 7A through 7C, only the laser light source 111 is accommodated in the laser holder 202, and a temperature adjuster including a Peltier element is not accommodated in the laser holder 202. In the embodiment, by performing the following processing, it is possible to accurately acquire three-dimensional data, even if a wavelength of laser light to be emitted from the laser light source 111 varies resulting from a temperature change.

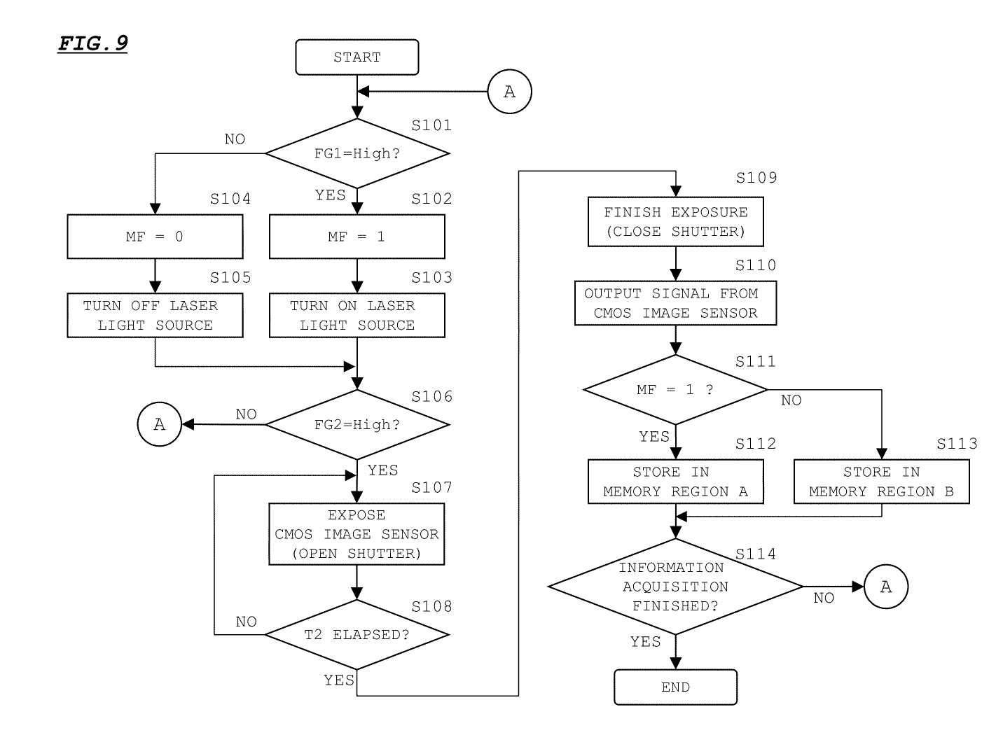

A DMP light imaging processing to be performed by the CMOS image sensor 125 is described referring to FIG. 8 and FIG. 9. FIG. 8 is a timing chart showing a light emission timing of laser light to be emitted from the laser light source 111, an exposure timing for the CMOS image sensor 125 and a storing timing of image data obtained by the CMOS image sensor 125 by the exposure. FIG. 9 is a flowchart showing an image data storing processing.

Referring to FIG. 8, the CPU 21 has functions of two function generators. With use of these functions, the CPU 21 generates pulses FG1 and FG2. The pulse FG1 is set high and low alternately at an interval T1. The pulse FG2 is outputted at a rising timing of the pulse FG1 and at a falling timing of the pulse FG1. For instance, the pulse FG2 is generated by differentiating the pulse FG1.

When the pulse FG1 is in a high-state, the laser controller 21a causes the laser light source 111 to be in an on state. Further, during a period T2 from the timing at which the pulse FG2 is set high, the shutter controller 21d causes the shutter 124 to be in an open state so that the CMOS image sensor 125 is exposed to light. After the exposure is finished, the CPU 21 causes the memory 25 to store image data obtained by the CMOS image sensor 125 by each exposure.

Referring to FIG. 9, if the pulse FG1 is set high (S101:YES), the CPU 21 sets a memory flag MF to 1 (S102), and causes the laser light source 111 to turn on (S103). Then, if the pulse FG2 is set high (S106:YES), the shutter controller 21d causes the shutter 124 to open so that the CMOS image sensor 125 is exposed to light (S107). The exposure is performed from an exposure start timing until the period T2 has elapsed (S108).

When the period T2 has elapsed from the exposure start timing (S108:YES), the shutter controller 21d causes the shutter 124 to close (S109), and image data obtained by the CMOS image sensor 125 is outputted to the CPU 21 (S110). Then, the CPU 21 determines whether the memory flag MF is set to 1 (S111). In this example, since the memory flag MF is set to 1 in Step S102 (S111:YES), the CPU 21 causes the memory 25 to store the image data outputted from the CMOS image sensor 125 into a memory region A of the memory 25 (S112).

Thereafter, if it is determined that the operation for acquiring information on the target area has not been finished (S114:NO), the processing returns to S101, and the CPU 21 determines whether the pulse FG1 is set high. If it is determined that that the pulse FG1 is set high, the CPU 21 continues to set the memory flag MF to 1 (S102), and causes the laser light source 111 to continue the on state (S103). Since the pulse FG2 is not outputted at this timing (see FIG. 8), the determination result in S106 is negative, and the processing returns to S101. In this way, the CPU 21 causes the laser light source 111 to continue the on state until the pulse FG1 is set low.

Thereafter, when the pulse FG1 is set low, the CPU 21 sets the memory flag MF to 0 (S104), and causes the laser light source 111 to turn off (S105). Then, if it is determined that the pulse FG2 is set high (S106:YES), the shutter controller 21d causes the shutter 124 to open so that the CMOS image sensor 125 is exposed to light (S107). The exposure is performed from an exposure start timing until the period T2 has elapsed in the same manner as described above (S108).

When the period T2 has elapsed from the exposure start timing (S108:YES), the shutter controller 21d causes the shutter 124 to close (S109), and image data obtained by the CMOS image sensor 125 is outputted to the CPU 21 (S110). Then, the CPU 21 determines whether the memory flag MF is set to 1 (S111). In this example, since the memory flag MF is set to 0 in Step S104 (S111:NO), the CPU 21 causes the memory 25 to store the image data outputted from the CMOS image sensor 125 into a memory region B of the memory 25 (S113).

The aforementioned processing is repeated until the information acquiring operation is finished. By performing the above processing, image data obtained by the CMOS image sensor 125 when the laser light source 111 is in an on state, and the image data obtained by the CMOS image sensor 125 when the laser light source 111 is in an off state are respectively stored in the memory region A and in the memory region B of the memory 25.

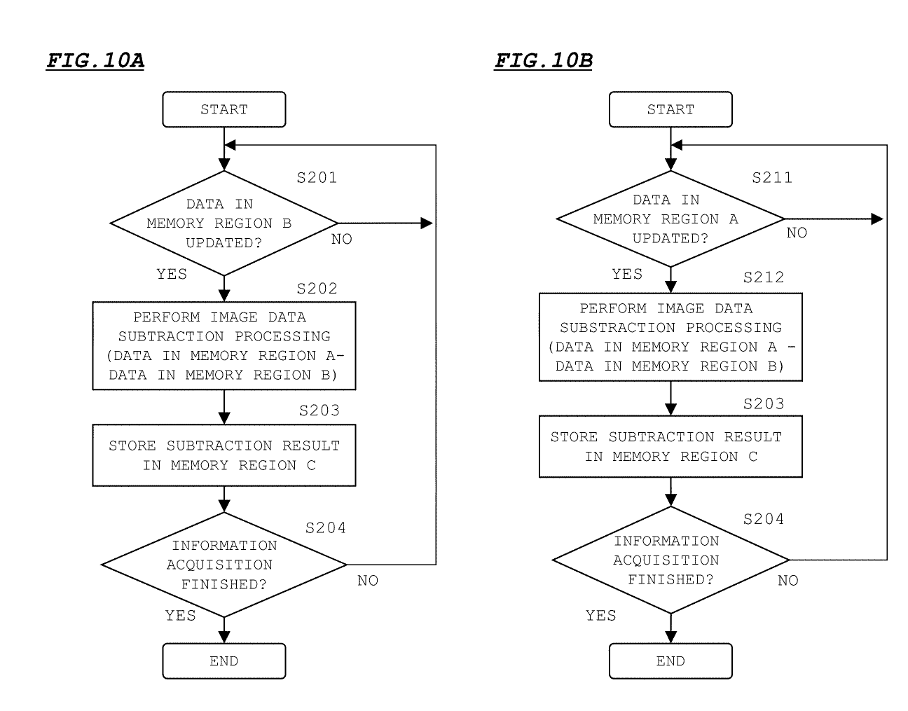

FIG. 10A is a flowchart showing a processing to be performed by the data subtractor 21b of the CPU 21.

When the image data is updated and stored in the memory region B (S201:YES), the data subtractor 21b performs a processing of subtracting the image data stored in the memory region B from the image data stored in the memory region A (S202). In this example, the value of a signal (electric charge) in accordance with a received light amount of each pixel which is stored in the memory region B is subtracted from the value of a signal (electric charge) in accordance with a received light amount of a pixel corresponding to the each pixel which is stored in the memory region A. The subtraction result is stored in a memory region C of the memory 25 (S203). If it is determined that the operation for acquiring information on the target area has not been finished (S204:NO), the processing returns to S201 and repeats the aforementioned processing.

By performing the processing shown in FIG. 10A, the subtraction result obtained by subtracting, from the image data (first image data) obtained when the laser light source 111 is in an on state, the image data (second image data) obtained when the laser light source 111 is in an off state immediately after the turning on of the laser light source 111, is updated and stored in the memory region C. In this example, as described above referring to FIGS. 8 and 9, the first image data and the second image data are acquired by exposing the CMOS image sensor 125 to light for the same period T2. Accordingly, the second image data corresponds to a noise component of light other than the laser light to be emitted from the laser light source 111, which is included in the first image data. Thus, image data obtained by removing a noise component of light other than the laser light to be emitted from the laser light source 111 is stored in the memory region C.

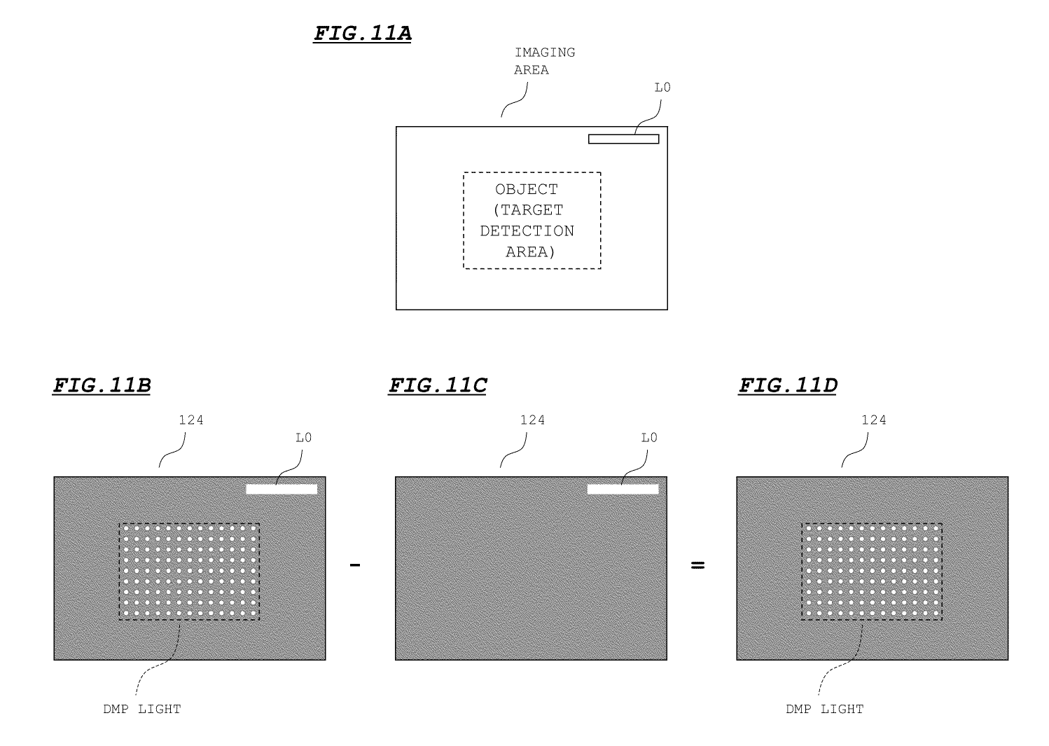

FIGS. 11A through 11D are diagrams schematically exemplifying an effect to be obtained by the processing shown in FIG. 10A.

As shown in FIG. 11A, in the case where a fluorescent lamp L0 is included in an imaging area, if the imaging area is captured by the light receiving optical system 12, while irradiating the imaging area with DMP light from the projection optical system 11 described in the embodiment, the captured image is as shown in FIG. 11B. Image data obtained based on the captured image in the above state is stored in the memory region A of the memory 25. Further, if the imaging area is captured by the light receiving optical system 12 without irradiating the imaging area with DMP light from the projection optical system 11, the captured image is as shown in FIG. 11C. Image data obtained based on the captured image in the above state is stored in the memory region B of the memory 25. A captured image obtained by removing the captured image shown in FIG. 11C from the captured image shown in FIG. 11B is as shown in FIG. 11D. Image data obtained based on the captured image shown in FIG. 11D is stored in the memory region C of the memory 25. Thus, image data obtained by removing a noise component of light (fluorescent light) other than DMP light is stored in the memory region C.

In this embodiment, a computation processing by the three-dimensional distance calculator 21c of the CPU 21 is performed, with use of the image data stored in the memory region C of the memory 25. This enhances the precision of three-dimensional distance information (information relating to a distance to each portion of an object to be detected) acquired by the above processing.

As described above, in the embodiment, since the light diffractive portion 112c is integrally formed on the light exit surface 112b of the collimator lens 112, the space for disposing the light diffractive element (DOE) 115 can be reduced, as compared with the arrangement shown in FIG. 4B. Thus, it is possible to miniaturize the projection optical system 11 in the optical axis direction of laser light.

Further, by performing the processing shown in FIGS. 8 through 11D, there is no need of disposing a temperature adjuster for suppressing a temperature change of the laser light source 111. This is further advantageous in miniaturizing the projection optical system 11. By performing the above processing, since the inexpensive filter 123 as described above can be used, it is possible to reduce the cost.

In the case where a noise component is removed by performing the subtraction processing as described above, theoretically, it is possible to acquire image data by DMP light, even without using the filter 123. However, generally, the light amount of light in a visible light wavelength band is normally higher than the light amount of DMP light by several orders. Therefore, it is difficult to accurately extract only DMP light from light including a light component in a visible light wavelength band by the subtraction processing. In view of the above, in this embodiment, the filter 123 is disposed for removing visible light as described above. The filter 123 may be any filter, as far as the filter is capable of sufficiently reducing the light amount of visible light which may be entered to the CMOS image sensor 125.

The embodiment of the invention has been described as above. The invention is not limited to the foregoing embodiment, and the embodiment of the invention may be changed or modified in various ways other than the above.

For instance, in the embodiment, the light exit surface 112b of the collimator lens 112 is formed into a flat surface. As far as the light diffractive portion 112c can be formed, the light exit surface 112b may be formed into a moderately curved surface. In the modification, by adjusting the shapes of the light incident surface 112a and the light exit surface 112b of the collimator lens 112, an off-axis aberration can be suppressed to some extent. If the light exit surface 112b is formed into a curved surface, however, it is difficult to form the light diffractive portion 112c by the process shown in FIGS. 5A through 5C.

Specifically, in the case where the light incident surface 112a and the light exit surface 112b are configured to realize both of conversion into parallel light and suppression of an aberration, normally, the light exit surface 112b is formed into an aspherical surface. If the light exit surface 112b serving as a surface to be transferred is formed into an aspherical surface as described above, a surface of the stamper 117 corresponding to the light exit surface 112b is also formed into an aspherical surface, as well as the light exit surface 112b. This makes it difficult to accurately transfer the concave-convex configuration 117a of the stamper 117 onto the UV curable resin layer 116. The diffraction pattern for generating laser light having a dot matrix pattern is fine and complex as shown in FIG. 5D. Therefore, in the case where a transfer operation is performed using the stamper 117, high precision is required for the transfer operation. Accordingly, in the case where the light diffractive portion 112c is formed by the process as shown in FIGS. 5A through 5C, as described in the embodiment, it is desirable to form the light exit surface 112b into a flat surface, and form the light diffractive portion 112c on the flat light exit surface 112b. With this arrangement, it is possible to precisely form the light diffractive portion 112c on the collimator lens 112.

Further, in the embodiment, the light diffractive portion 112c is formed on the light exit surface 112b of the collimator lens 112. Alternatively, the light incident surface 112a of the collimator lens 112 may be formed into a flat surface or a moderately curved surface, and the light diffractive portion 112c may be formed on the light incident surface 112a. In the case where the light diffractive portion 112c is formed on the light incident surface 112a, however, it is necessary to design a diffraction pattern of the light diffractive portion 112c with respect to laser light to be entered as diffusion light. This makes it difficult to perform optical design of the diffraction pattern. Further, since it is necessary to design the surface configuration of the collimator lens 112 with respect to laser light diffracted by the light diffractive portion 112c, it is also difficult to perform optical design of the collimator lens 112.

On the other hand, in the embodiment, since the light diffractive portion 112c is formed on the light exit surface 112b of the collimator lens 112, it is only necessary to design a diffraction pattern of the light diffractive portion 112c based on the premise that laser light is parallel light. This is advantageous in facilitating optical design of the light diffractive portion 112c. Further, since it is only necessary to design the collimator lens 112 based on the premise that laser light is diffusion light without diffraction, it is easy to perform optical design.

In FIG. 10A of the embodiment, a subtraction processing is performed as the data in the memory region B is updated. Alternatively, as shown in FIG. 10B, a subtraction processing may be performed as the data in the memory region A is updated. In the modification, if the data in the memory region A is updated (S211:YES), a processing of subtracting second image data from first image data which is updated and stored in the memory region A is performed, using the second image data stored in the memory region B immediately before the updating of the first image data (S212). Then, the subtraction result is stored in the memory region C (S203).

In the embodiment, the CMOS image sensor 125 is used as a light receiving element. Alternatively, a CCD image sensor may be used.

The embodiment of the invention may be changed or modified in various ways as necessary, as far as such changes and modifications do not depart from the scope of the claims of the invention hereinafter defined.

What is claim is:

1. An information acquiring device for acquiring information on a target area using light, comprising:
a light source which emits laser light of a predetermined wavelength band;
a collimator lens which converts the laser light emitted from the light source into parallel light;
a light diffractive portion which is formed on a light incident surface or a light exit surface of the collimator lens, and converts the laser light into laser light having a dot pattern by diffraction of the light diffractive portion;
alight receiving element which receives reflected light reflected on the target area for outputting a signal; and
an information acquiring section which acquires three-dimensional information of an object in the target area based on the signal to be outputted from the light receiving element.

2. The information acquiring device according to claim 1, wherein
the light exit surface of the collimator lens is formed into a flat surface, and
the light diffractive portion is formed on the light exit surface of the collimator lens.

3. The information acquiring device according to claim 2, wherein
the light diffractive portion is formed by transferring a diffraction pattern for generating laser light having the dot pattern onto a resin material formed on the light exit surface of the collimator lens.

4. The information acquiring device according to claim 2, further comprising:
a tilt correction mechanism which holds the collimator lens and corrects a tilt of an optical axis of the collimator lens with respect to an optical axis of the laser light.

5. The information acquiring device according to claim 1, further comprising:
a light source controller which controls the light source; and
a storage which stores signal value information relating to a value of the signal outputted from the light receiving element, wherein
the light source controller controls the light source to repeat emission and non-emission of the light,
the storage stores first signal value information relating to a value of a signal outputted from the light receiving element during a period when the light is emitted from the light source, and second signal value information relating to a value of a signal outputted from the light receiving element during a period when the light is not emitted from the light source, and
the information acquiring section acquires the three-dimensional information of the object in the target area, based on a subtraction result obtained by subtracting the second signal value information from the first signal value information stored in the storage.

6. An object detecting device, comprising:
an information acquiring device which acquires information on a target area using light,
the information acquiring device including:
a light source which emits laser light of a predetermined wavelength band;
a collimator lens which converts the laser light emitted from the light source into parallel light;
a light diffractive portion which is formed on a light incident surface or a light exit surface of the collimator lens, and converts the laser light into laser light having a dot pattern by diffraction of the light diffractive portion;
a light receiving element which receives reflected light reflected on the target area for outputting a signal; and
an information acquiring section which acquires three-dimensional information of an object in the target area based on the signal to be outputted from the light receiving element.

7. The object detecting device according to claim 6, wherein
the light exit surface of the collimator lens is formed into a flat surface, and
the light diffractive portion is formed on the light exit surface of the collimator lens.

8. The object detecting device according to claim 7, wherein
the light diffractive portion is formed by transferring a diffraction pattern for generating laser light having the dot pattern onto a resin material formed on the light exit surface of the collimator lens.

9. The object detecting device according to claim 7, further comprising:
a tilt correction mechanism which holds the collimator lens and corrects a tilt of an optical axis of the collimator lens with respect to an optical axis of the laser light.

10. The object detecting device according to claim 6, further comprising:
a light source controller which controls the light source; and
a storage which stores signal value information relating to a value of the signal outputted from the light receiving element, wherein
the light source controller controls the light source to repeat emission and non-emission of the light,
the storage stores first signal value information relating to a value of a signal outputted from the light receiving element during a period when the light is emitted from the light source, and second signal value information relating to a value of a signal outputted from the light receiving element during a period when the light is not emitted from the light source, and
the information acquiring section acquires the three-dimensional information of the object in the target area, based on a subtraction result obtained by subtracting the second signal value information from the first signal value information stored in the storage.
